(19) United States
(12) Patent Application Publication
(10) Pub. No.: US 2012/0131945 A1
(43) Pub. Date: May 31, 2012

(54) Self-Starting Type Axial Gap Synchronous Motor, Compressor and Refrigeration Cycle Apparatus Using the Same

(75) Inventors: Baiying HUANG, Shizuoka (JP); Ryoji Sato, Shizuoka (JP); Hiroyasu Yoneyama, Yaizu (JP)

(73) Assignee: Hitachi Appliances, Inc., Tokyo (JP)

(21) Appl. No.: 13/301,053

(22) Filed: Nov. 21, 2011

(30) Foreign Application Priority Data
Nov. 26, 2010 (JP) 2010-263432

(51) Int. Cl. H02K 16/00; F04B 35/04; F25D 17/06

(52) U.S. Cl. 62/426; 310/114; 417/410.1

(57) ABSTRACT

A self-starting type axial gap synchronous motor includes a stator in which plural small stators are arranged on the same circumference; disc-shaped rotors in each of which plural permanent magnets facing the stator are arranged on the same circumference; and a shaft coupled to the rotors. Each of the disc-shaped rotors includes a metal frame that is provided so as to surround the plural permanent magnets arranged on the same circumference, and each of the metal frames is configured using a nonmagnetic and conductive material.

Accordingly, it is possible to obtain a self-starting type axial gap synchronous motor that can be started by a commercial electric power without using an inverter, and a compressor and a refrigeration cycle apparatus using the same.

### BACKGROUND OF THE INVENTION

(1) Field of the Invention

The present invention relates to a self-starting type axial gap synchronous motor having an axial gap type induction and synchronous motor in which rotors and a stator are oppositely arranged in the axial direction, and a compressor and a refrigeration cycle apparatus using the same.

(2) Description of the Related Art

For example, Japanese Patent Application Laid-Open No. 2009-38871 discloses a conventional axial gap motor having an axial gap type induction and synchronous motor. In the conventional technique, a PM (permanent magnet) rotor in which plural permanent magnets are arranged in the circumferential direction at even intervals and an IN rotor as an induction motor are arranged on both sides of a stator in the axial direction, the both rotors are fixed to a common rotational shaft, and air gaps are provided between the rotors and the stator, so that the rotors can be rotated.

Japanese Patent Application Laid-Open No. 2009-38871 describes the invention in which the IM rotor and the PM rotor are simultaneously driven during power running to obtain strong torque.

However, if the induction and synchronous axial gap motor described in Japanese Patent Application Laid-Open No. 2009-38871 is started by a commercial electric power, rotary torque is generated at the IM rotor because the IM rotor is used as an induction motor. However, the PM rotor functions as a brake to increase a load, and thus sufficient starting induction torque cannot be possibly obtained. Specifically, in Japanese Patent Application Laid-Open No. 2009-38871, starting of the induction and synchronous axial gap motor by a commercial electric power is not considered.

Further, in Japanese Patent Application Laid-Open No. 2009-38871, only the PM rotor provided on one side of the stator contributes to synchronous operations by a commercial electric power, and no torque is generated by the IM rotor on the other side. Thus, it is difficult to obtain high rotary torque as a whole, and it is impossible to withstand a large load.

Further, as a general stator core of a motor, electromagnetic metal plates are laminated on each other. However, in the stator core using the electromagnetic metal plates, eddy current proportional to the square of the thickness of the electromagnetic metal plate, is generated at the electromagnetic metal plates of the stator core under the influence of rotating magnetic fields generated at the time of rotation of the motor to cause a large loss. The loss is one of the factors of deteriorating the efficiency of the motor. Accordingly, it is necessary to reduce the loss (iron loss) in order to improve the efficiency of the motor.

It should be noted that in the case where the axial gap type motor is configured in such a manner that permanent magnets with different poles are arranged in rotors arranged on both end sides of a stator, cogging torque thereof is expected to be larger than that of a conventional radial gap type motor.

An object of the present invention is to obtain a self-starting type axial gap synchronous motor that can be started by a commercial electric power without using an inverter, and a compressor and a refrigeration cycle apparatus using the same.

### SUMMARY OF THE INVENTION

In order to achieve the above-described object, the present invention provides a self-starting type axial gap synchronous motor including: a stator in which plural small stators are arranged on the same circumference; disc-shaped rotors in each of which plural permanent magnets facing the stator are arranged on the same circumference; and a shaft coupled to the rotors, wherein each of the disc-shaped rotors includes a metal frame that is provided so as to surround the plural permanent magnets arranged on the same circumference, and each of the metal frames is configured using a nonmagnetic and conductive material.

Further, according to another aspect of the present invention, there is provided a compressor including a compression mechanical unit and a motor that drives the compression mechanical unit, wherein the motor is configured using the self-starting type axial gap synchronous motor.

Further, according to yet another aspect of the present invention, there is provided a refrigeration cycle apparatus including a condenser and an evaporator, each having a fan driven by a motor, wherein the motor of the fan provided in at least any one of the condenser and the evaporator is configured using the self-starting type axial gap synchronous motor.

According to the present invention, it is possible to obtain a self-starting type axial gap synchronous motor that can be started by a commercial electric power without using an inverter, and a compressor and a refrigeration cycle apparatus using the same.

### BRIEF DESCRIPTION OF THE DRAWINGS

FIG. 1 is a vertical cross-sectional view for showing a self-starting type axial gap synchronous motor according to a first embodiment of the present invention;

FIG. 2 are diagrams for showing a configuration of a rotor of the synchronous motor shown in FIG. 1, FIG. 2A is a side cross-sectional view, and FIG. 2B is a cross-sectional view taken along the arrow B-B of FIG. 2A;

FIG. 3 are diagrams for explaining a configuration of a metal frame configuring the rotor shown in each of FIG. 1 and FIG. 2 and the directions of induction current and rotational force generated at the time of starting the rotor, FIG. 3A is a side cross-sectional view, and FIG. 3B is a cross-sectional view taken along the arrow C-C of FIG. 3A;

FIG. 4 are diagrams for explaining a configuration of a small stator that is a constitutional member of the stator shown in FIG. 1, FIG. 4A is a perspective view of a small stator core, FIG. 4B is a perspective view for showing a configuration of a nonmagnetic member shown in FIG. 4A, and FIG. 4C is a perspective view for showing the small stator obtained by winding a coil around the small stator core shown in FIG. 4A;

FIG. 5 is a cross-sectional view taken along the arrow A-A of FIG. 1;

FIG. 6 are perspective views for showing various configuration examples of a small stator core used for a self-starting type axial gap synchronous motor according to a second embodiment of the present invention;

FIG. 7 are perspective views for showing various configuration examples of a small stator core used for a self-starting type axial gap synchronous motor according to a third embodiment of the present invention;

FIG. 8 are diagrams for showing a configuration of a rotor used for a self-starting type axial gap synchronous motor according to a fourth embodiment of the present invention, FIG. 8A is a side cross-sectional view, and FIG. 8B is a cross-sectional view taken along the arrow F-F of FIG. 8A;

FIG. 9 shows a fifth embodiment of the present invention, and is a vertical cross-sectional view for showing a scroll compressor having a self-starting type axial gap synchronous motor; and

FIG. 10 is a refrigeration cycle configuration diagram for showing an air conditioner having a self-starting type axial gap synchronous motor according to a sixth embodiment of the present invention.

### DETAILED DESCRIPTION OF THE EMBODIMENT

Hereinafter, embodiments of the present invention will be described on the basis of the drawings.

### First Embodiment

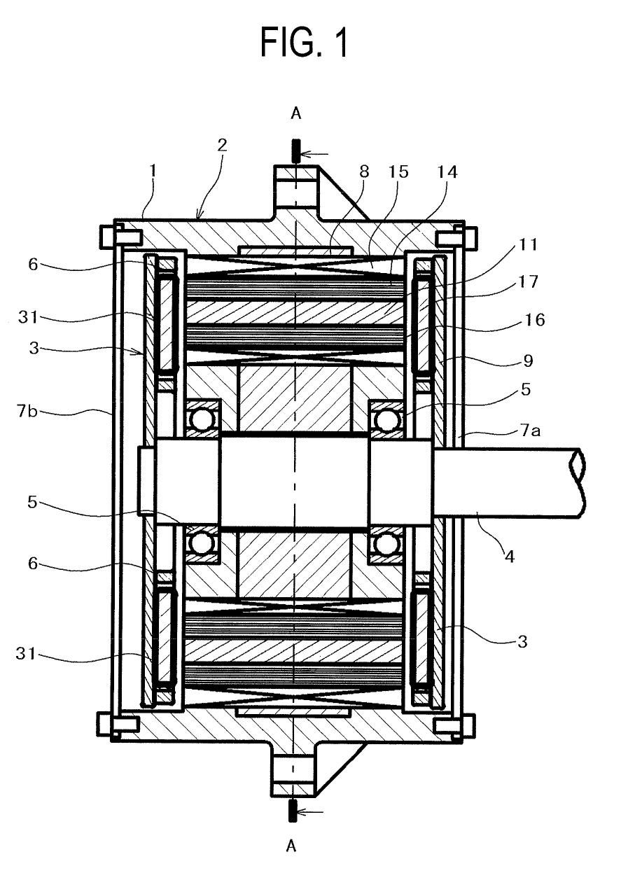

A self-starting type axial gap synchronous motor according to a first embodiment of the present invention will be described using FIG. 1 to FIG. 5. FIG. 1 is a vertical cross-sectional view for showing a self-starting type axial gap synchronous motor of the embodiment.

As shown in FIG. 1, a self-starting type axial gap synchronous motor 1 includes a stator 2 formed by inserting plural small stators 16 into a holder 8 for molding, disc-like rotors 3, a shaft 4 that is rotatably supported by the stator 2 through a bearing 5, and brackets 7a and 7b that are attached to the stator 2 so as to accommodate the rotors 3 therein. The brackets 7a and 7b are used to protect the rotors 3, and are attached to end portions of the stator 2.

The rotors 3 are oppositely arranged on both end sides of the stator 2 so as to sandwich the stator 2, and are fixed to the shaft 4. Plural permanent magnets 17 are arranged on the same circumference of each rotor 3 at even intervals, and are provided at positions facing the plural small stators 16. Further, each of the rotors 3 is fixed to the shaft 4 while having a certain gap (smaller than 2 mm) with respect to each of both end surfaces of the stator 2, and can be freely rotated together with the shaft 4.

It should be noted that the small stators 16 are configured using small stator cores 14 and coils 15 wound around the small stator cores 14, and a nonmagnetic member 11 is provided in the middle of each small stator core 14. Further, the rotors 3 include nonmagnetic disks 9 and metal frames 6 fixed to the disks 9, and the respective permanent magnets 17 are surrounded by the metal frames 6. Further, the metal frames 6 and the permanent magnets 17 are fixed to the disks 9 through insulating papers 31.

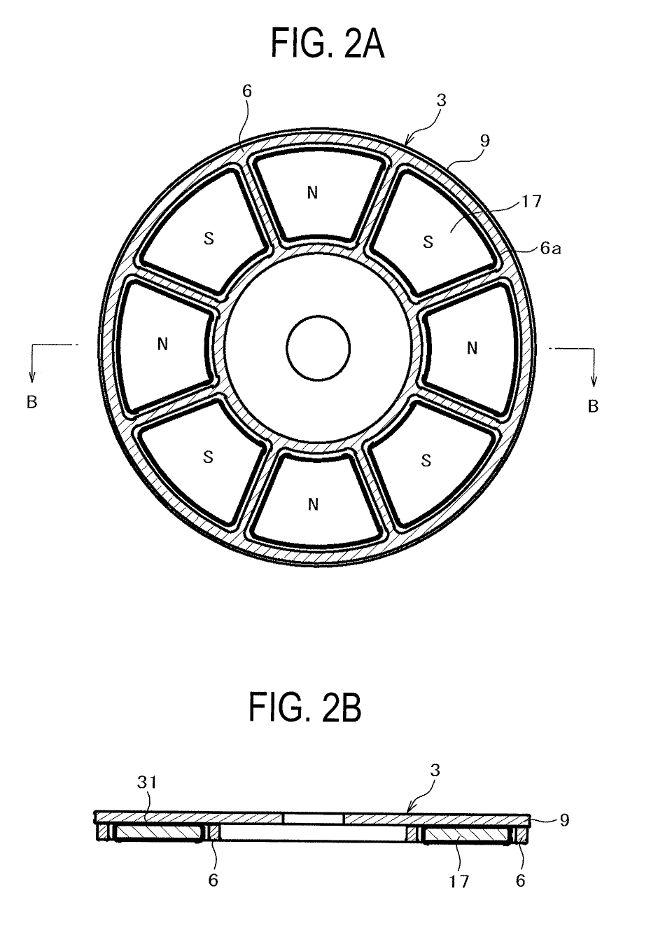

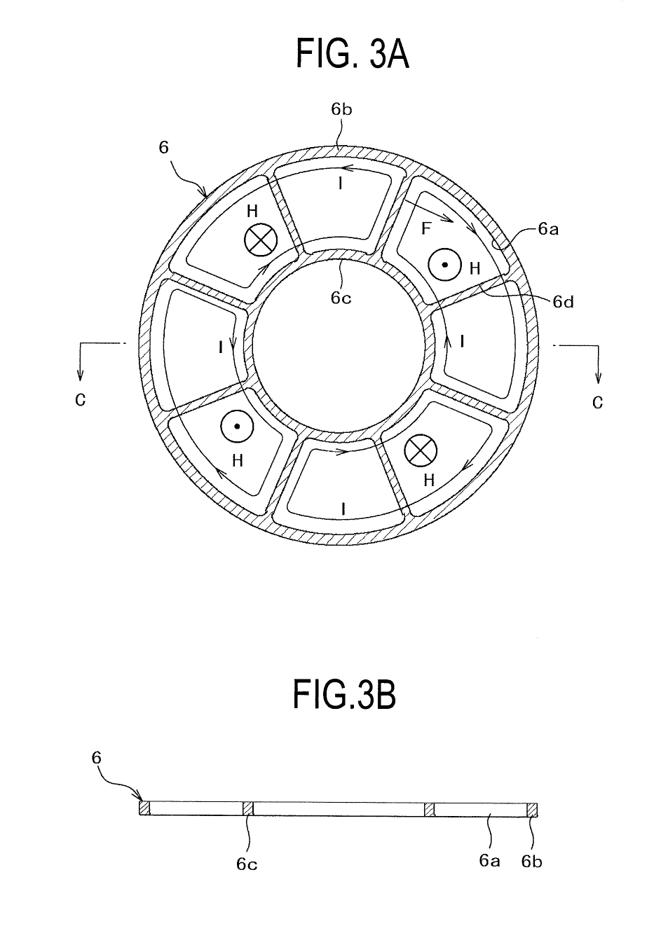

FIG. 2 are diagrams for showing a configuration of the rotor 3 shown in FIG. 1, FIG. 2A is a side cross-sectional view of the rotor, and FIG. 2B is a cross-sectional view taken along the arrow B-B of FIG. 2A. FIG. 3 are diagrams for showing a configuration of the metal frame configuring the rotor shown in each of FIG. 1 and FIG. 2, FIG. 3A is a side cross-sectional view, and FIG. 3B is a cross-sectional view taken along the arrow C-C of FIG. 3A.

As shown in FIG. 2, the rotor 3 includes the nonmagnetic disk 9 and the metal frame 6 (see FIG. 3) configured using a nonmagnetic material (which may be metal or nonmetal) and a conductive material, and the metal frame 6 is concentrically arranged at the disk 9. The disk 9 and the metal frame 6 are attached to each other while interposing an insulating material (insulating paper or the like) 31 therebetween. It should be noted that the disk 9 is fixed to the shaft 4.

In the embodiment, the diameter of the metal frame 6 is substantially equal to that of the disk 9, the material thereof is aluminum (including aluminum alloy) or copper (including copper alloy), and is produced by a method such as aluminum die-casting or forging.

Plural holes 6a in which the permanent magnets 17 are arranged are provided at the metal frame 6 in the circumferential direction at even intervals. The permanent magnets 17 are arranged in the respective holes 6a provided at even intervals, and are fixed to the disk 9 using an adhesive or the like. The outer circumference of each of the permanent magnets 17 may be brought into contact with the metal frame 6. Alternatively, a space may be provided so as not to allow the outer circumference of each of the permanent magnets 17 to be brought into contact with the metal frame 6.

After assembling the rotor 3, the permanent magnets 17 are magnetized to serve as permanent magnets by supplying pulse current using a magnetization device. Further, as shown in FIG. 2, the magnets that are adjacent to each other in the circumferential direction are magnetized so as to have different poles. A ferrite magnet or a rare-earth magnet is preferable as the material of each permanent magnet 17. Further, each permanent magnet 17 is preferably formed in a substantially fan shape as shown in FIG. 2. However, each permanent magnet 17 may be formed in a rectangular shape, a square shape, an elliptical shape, or a circular shape. The thicknesses of the permanent magnets 17 may be uniform or non-uniform.

An axial gap between the stator 2 and each rotor 3 after being assembled as a motor is set at 2 mm or smaller to avoid contact, and may be uniform or non-uniform. It should be noted that each axial gap is preferably as small as possible to avoid contact. In general, each axial gap is preferably set at 0.3 to 1.5 mm, and more preferably 0.4 to 0.8 mm.

A configuration of the metal frame 6 that is provided so as to surround the plural permanent magnets arranged on the same circumference will be described using FIG. 3. The metal frame 6 includes outer circumferential members 6b that connect the outer circumferential sides of the permanent magnets 17 in the circumferential direction, inner circumferential members 6c that connect the inner circumferential sides of the permanent magnets 17 in the circumferential direction, and radial members 6d each of which is provided between the permanent magnets 17 arranged in the circumferential direction and which connect the outer circumferential members 6b to the inner circumferential members 6c. The permanent magnets 17 are arranged in the holes 6a formed by the outer circumferential members 6b, the inner circumferential members 6c, and the radial members 6d.

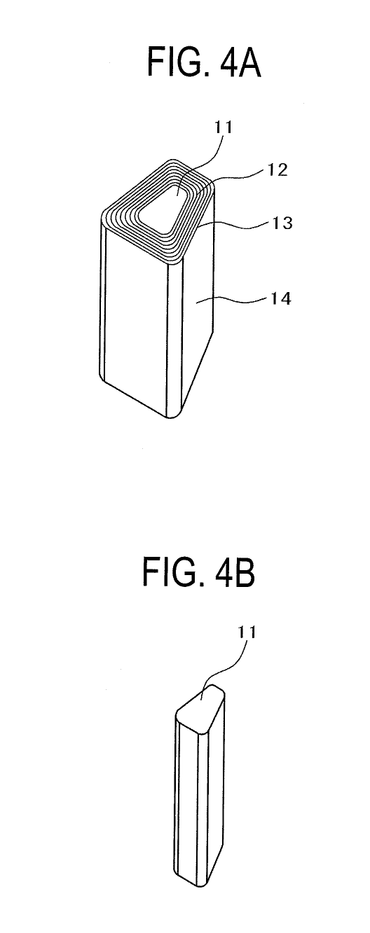

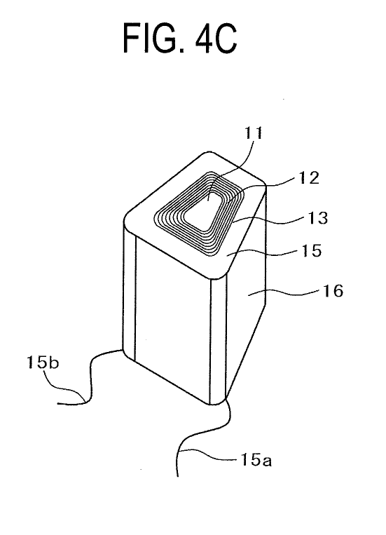

A configuration of each of the plural small stators 16 that configure the stator 2 and are arranged in the circumferential direction will be described using FIG. 4. FIG. 4 are diagrams for explaining a configuration of the small stator 16 that is a constitutional member of the stator shown in FIG. 1. FIG. 4A is a perspective view of the small stator core, FIG. 4B is a perspective view for showing a configuration of the nonmagnetic member shown in FIG. 4A, and FIG. 4C is a perspective view for showing the small stator obtained by winding a coil around the small stator core shown in FIG. 4A.

As shown in FIG. 4A, the small stator core 14 having a fan-shaped cross-section is produced in such a manner that an amorphous ribbon 12 on one surface of which an insulating film having a thickness of a few micrometers is provided is wound around the outer circumference of the nonmagnetic member 11 up to a predetermined dimension, and the amorphous ribbon 12 is cut off and is hardened using a coating material 13 such as an adhesive or resin, or is fixed using an insulating paper with an adhesive.

The nonmagnetic member 11 has a substantially fan-shaped cross-section with a certain length as shown in FIG. 4B, and is produced by a method such as resin molding. The shape of the nonmagnetic member 11 is not limited to the fan shape, but may be a circular shape, an elliptical shape, or a trapezoidal shape.

As shown in FIG. 4C, the small stator 16 is produced in such a manner that the coil (preferably, three-phase coil) 15 is wound around the small stator core 14 produced as FIG. 4A, and both line ends 15a and 15b of the coil 15 are pulled outside.

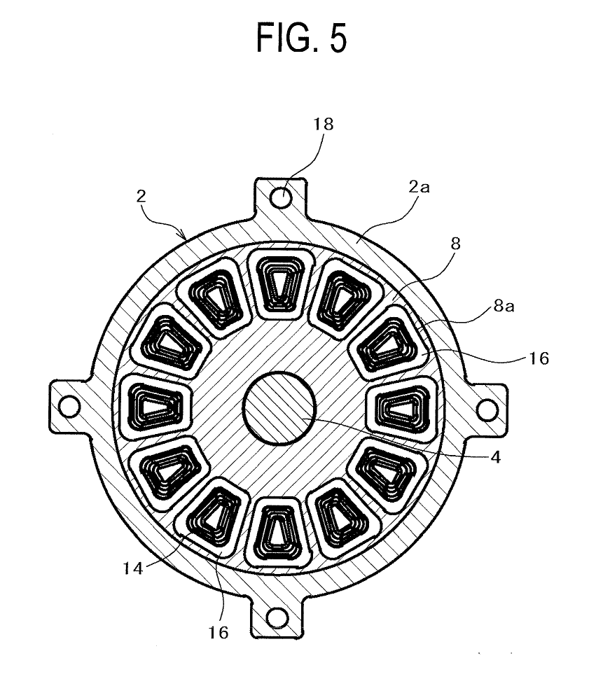

Next, a structure of the stator 2 shown in FIG. 1 will be described using FIG. 5. FIG. 5 is a cross-sectional view taken along the arrow A-A of FIG. 1, and is a cross-sectional view of the self-starting type axial gap synchronous motor according to the embodiment. Constitutional elements having the same reference numerals as those in FIG. 1 are the same constitutional elements. In FIG. 5, the reference numeral 8 denotes a holder for holding the small stators 16 shown in FIG. 4C in the circumferential direction at even intervals. The holder is produced by a method such as resin molding using a nonmagnetic material, and is arranged concentrically with the shaft 4. The plural small stators 16 are inserted, mounted, and fixed to respective holes 8a provided in the outer circumferential direction of the holder 8 at even intervals, the line ends 15a and 15b of the three-phase coil (U, V, and W) of each small stator 16 are tied, and resin 2a is poured into a die, so that the stator 2 is integrally molded. It should be noted that the reference numeral 18 in FIG. 5 denotes a motor attachment portion.

In the embodiment, the motor is configured using a 12-pole stator and 8-pole rotors. However, a different combination may be employed as the pole ratio between the stator and the rotors.

Further, the rotors 3 and the stator 2 may be inversely arranged so as to arrange the rotors in the middle, and the stators may be arranged on the both end sides of the rotors.

Next, the reason that the rotary torque is generated to drive the self-starting type axial gap synchronous motor as described above will be described using, especially, FIG. 3. The directions of induction current and rotational force generated at the metal frame 6 of the rotor at the time of starting the motor will be described using FIG. 3.

When current is applied to the three-phase coils 15 of the stator 2 by a commercial electric power, rotating magnetic fields H are generated by the coils 15 as shown in FIG. 3. Then, electromotive force is induced to the metal frame 6 provided at the rotor 3 that is opposed to the stator 2, and current I flows to respective circuits configured by the metal frame 6. At this time, rotational force F as shown in FIG. 3 is generated, in accordance with the Fleming's left-hand rule, at the conductive metal frame 6 into which the current is flowing under the influence of the rotating magnetic fields H. Accordingly, the rotary torque is generated at the rotor 3, and the motor is driven and accelerated as an induction motor to increase the number of rotations. When the number of rotations of each rotor 3 becomes closer to the number of synchronous rotations, each rotor 3 is drawn into the synchronous speed of the rotating magnetic fields by the action of the permanent magnets 17 provided at the rotors 3, and the motor is driven as a synchronous motor.

According to the above-described embodiment, it is possible to obtain a motor that can be operated at a constant speed by a commercial electric power without inverter control, and circuits for inverter control are not needed, resulting in cost reduction.

Further, the stator 2 is produced in such a manner that each of the small stator cores 14 is produced by winding the amorphous ribbon with low iron loss and high magnetic permeability in a roll shape, the coil 15 is wound around each of the small stator cores 14 to produce the small stator 16, and the small stators 16 are arranged in the circumferential direction. Thus, not only the stator 2 can be produced by simple production steps, but also a high-efficiency self-starting type axial gap synchronous motor with less iron loss can be realized.

Thus, according to the embodiment, it is possible to obtain a high-efficiency and high power-factor self-starting type axial gap synchronous motor that can be operated at a constant speed by a commercial electric power without using an inverter.

### Second Embodiment

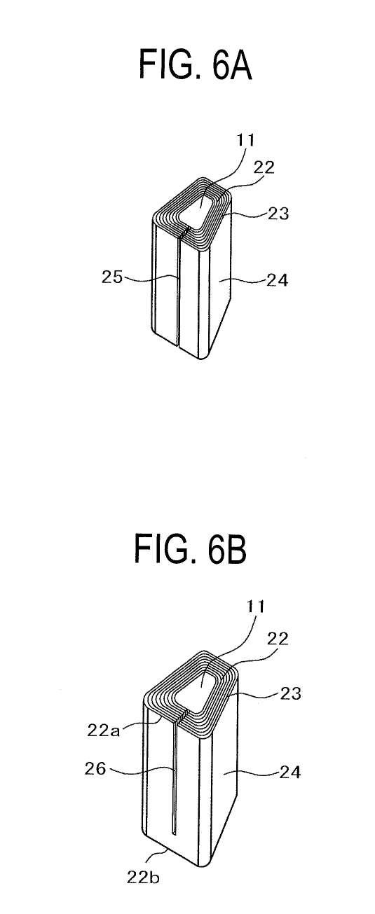

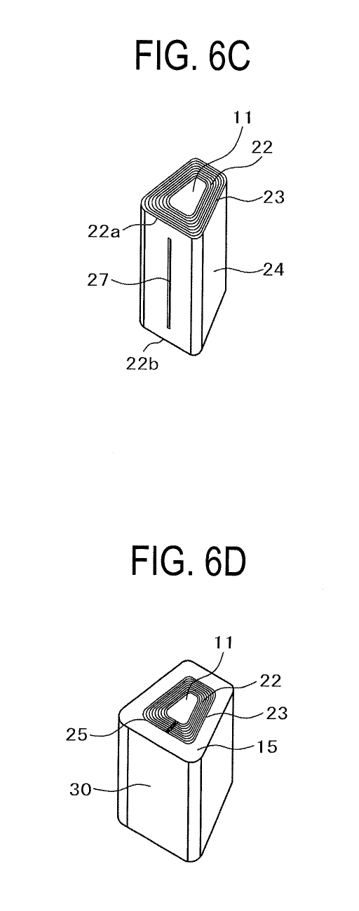

Next, a second embodiment of the present invention will be described using FIG. 6. FIG. 6 are perspective views for showing various configuration examples of the small stator core used for a self-starting type axial gap synchronous motor according to the second embodiment of the present invention.

A small stator core 24 shown in FIG. 6A corresponds to the small stator core 14 in the first embodiment. In the second embodiment, an amorphous ribbon 22 on one surface of which an insulating film is provided is wound around the nonmagnetic member 11 with a certain length, and then is hardened using a coating material 23 such as an adhesive to produce the small stator core 24 made of amorphous having a fan-shaped cross-section, as similar to the first embodiment. It should be noted that the amorphous ribbon 22 and the nonmagnetic member 11 may be fixed together using resin or a tape, instead of the coating material 23 such an adhesive.

When operating the motor, reflux-like eddy current is generated at the lamination plane of the small stator core 24 under the influence of the rotating magnetic fields to cause a loss. The loss caused by the eddy current is one of the factors of lowering the efficiency of the motor. In order to reduce the loss caused by the eddy current, a slit 25 having a width of 2 mm or smaller is provided at the lamination plane of each small stator core 24 in the axial direction so as to cut the amorphous ribbon 22 in the embodiment. The slit 25 is formed in the middle of a plane portion of the amorphous ribbon 22 in the axial direction as shown in FIG. 6A, and the cutting width is preferably 2 to 1 mm.

By providing the slit 25, a loop where the eddy current is formed can be opened, and it is possible to prevent the eddy current from being formed on the lamination plane of each small stator core 24. Thus, it is possible to obtain a self-starting type axial gap synchronous motor that can further improve efficiency by reducing the loss as compared to that in the first embodiment.

It should be noted that the slit 25 is not limited to the slit penetrating the amorphous ribbon 22 in the axial direction as shown in FIG. 6A, but may be a slit 26 that is open to one end surface 22a of the small stator core 24 and is not open (cut) to the other end surface 22b as shown in FIG. 6B. It should be noted that the slit may be a slit 27 that is open to neither the end surfaces 22a nor 22b of the small stator core 24 as shown in FIG. 6C.

A small stator 30 is formed in such a manner that as shown in FIG. 6D, the coil 15 is wound around the small stator core 24 shown in FIGS. 6A to 6C. As similar to the first embodiment, the plural small stators 30 are arranged in the circumferential direction using the holder 8, and are molded together with the holder 8 using resin to produce the stator 2.

According to the embodiment, the same effects as those in the first embodiment can be obtained, the loss of the stator configured using the amorphous core material with a low loss can be further reduced, and thus the efficiency of the self-starting type axial gap motor can be further improved.

### Third Embodiment

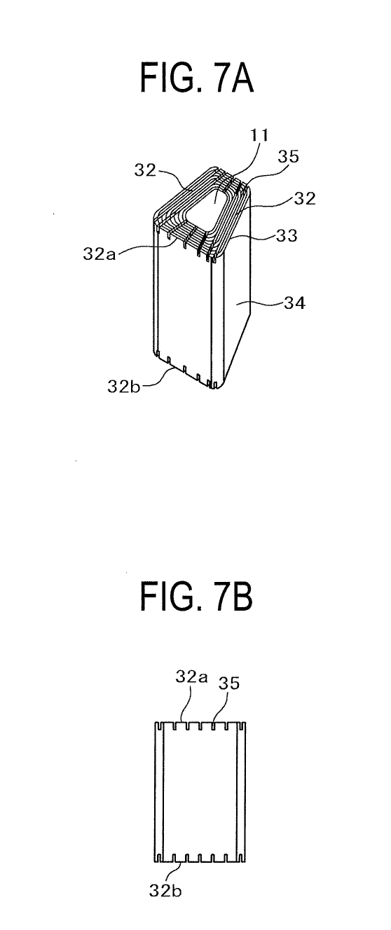

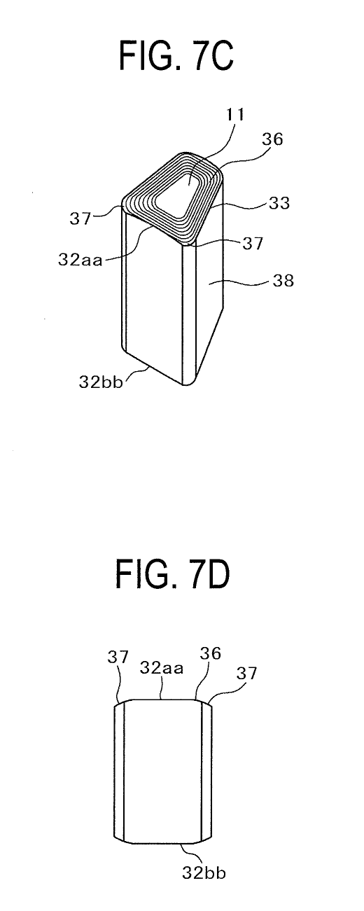

A third embodiment of the present invention will be described using FIG. 7. FIG. 7 are perspective views for showing various configuration examples of the small stator core used for a self-starting type axial gap synchronous motor according to the third embodiment of the present invention.

FIG. 7A is a perspective view of a small stator core 34 as a first example of the third embodiment, and FIG. 7B is a front view of the small stator core shown in FIG. 7A. Further, FIG. 7C is a perspective view of a small stator core 38 as a second example of the third embodiment, and FIG. 7D is a front view of the small stator core shown in FIG. 7C.

The small stator cores 34 and 38 shown in FIG. 7 correspond to the small stator core 14 in the first embodiment. In the third embodiment, an amorphous ribbon 32 on one surface of which an insulating film is provided is wound around the nonmagnetic member 11 with a certain length, and then is hardened using a coating material 33 such as an adhesive, or the amorphous ribbon 32 and the nonmagnetic member 11 are fixed together using resin or a tape to produce the small stator core 34 made of amorphous having a fan-shaped cross-section, as similar to the first embodiment.

When the motor shown in FIG. 1 is operated as a synchronous motor, the cogging torque is generated between the permanent magnets 17 and the small stator cores 14. The cogging torque is excitation force as vibration of the motor. Thus, when the cogging torque matches the unique frequency of the motor, high-level noise is disadvantageously generated. Accordingly, the embodiment employs the following configuration to reduce the cogging torque.

In the first example shown in FIGS. 7A and 7B, plural slits 35 each having a width of 0.1 to 1.5 mm and a depth of 0.5 to 2 mm are provided, in the radial direction, at portions of each small stator core 34 facing the permanent magnets 17 of the rotors 3, namely, at both end surfaces 32a and 32b of each small stator core 34. The slits 35 are formed on the outer circumferential side and the inner circumferential side of the amorphous ribbon 32 configuring the small stator core 34. With such a configuration, it is possible to obtain a self-starting type axial gap synchronous motor in which the amplitude of the cogging torque generated between the permanent magnets 17 and the small stator cores 34 can be reduced, and vibration and noise can be suppressed.

Next, the second example shown in FIGS. 7C and 7D will be described. In the second example, both end surfaces 32aa and 32bb of each small stator core 38 facing the permanent magnets 17 are configured in such a manner that a middle portion of the small stator core 38 is thick in the axial direction and both sides 37 thereof in the circumferential direction are thin in the axial direction. Specifically, curved surfaces 36 are provided at the both end surfaces 32aa and 32bb so as to make the thickness of the small stator core 38 non-uniform in the axial direction.

With such a configuration, induction voltage induced by the coil 15 wound around the small stator core 38 is smoothly changed in the circumferential direction of the small stator core 38 when the motor is rotated. Thus, the amplitude of the cogging torque generated between the stator 2 and the adjacent permanent magnets 17 with different poles (S and N poles) is reduced by the induction voltage that is smoothly changed in the circumferential direction. As a result, it is possible to obtain a self-starting type axial gap synchronous motor in which vibration and noise can be suppressed.

According to the embodiment, the same effects as those in the first embodiment can be obtained, and the noise and vibration of the high-efficiency self-starting type axial gap synchronous motor configured using the amorphous core material with a low loss can be advantageously reduced.

### Fourth Embodiment

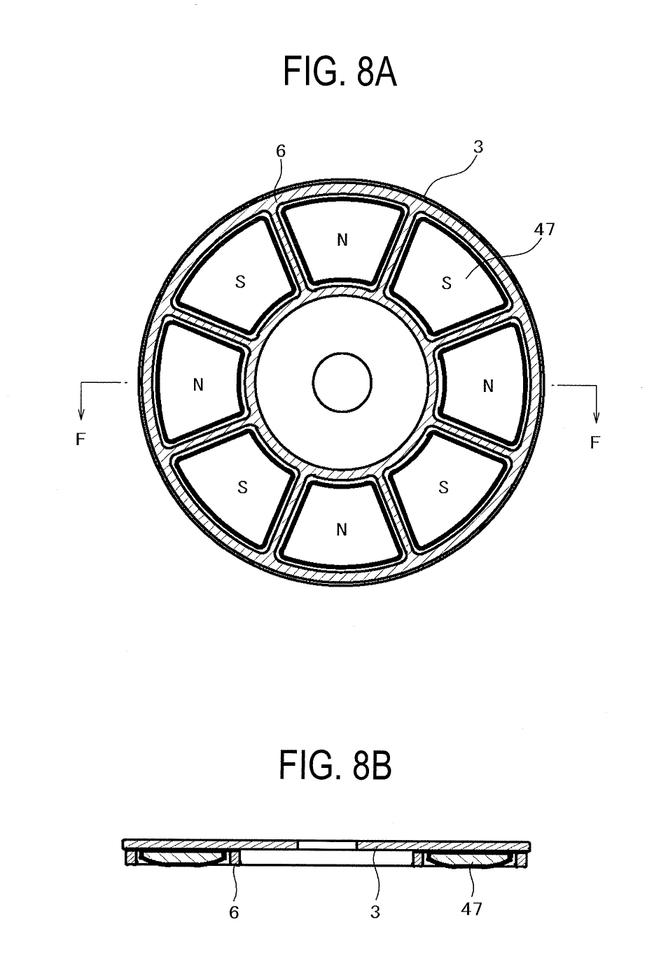

FIG. 8 are diagrams for showing a configuration of a rotor used for a self-starting type axial gap synchronous motor according to a fourth embodiment of the present invention. FIG. 8A is a side cross-sectional view, and FIG. 8B is a cross-sectional view taken along the arrow F-F of FIG. 8A.

In the fourth embodiment, the thickness of each permanent magnet 47 provided in the metal frame 6 of the rotor 3 is changed. For example, the surface of a middle portion of each permanent magnet 47 may be formed in a convex hemisphere shape, or the surface of each permanent magnet 47 may be formed in a curved shape in which the both end portions in the circumferential direction are thinner than the middle portion in the circumferential direction.

With such a configuration, gaps between the small stator cores 14 and the permanent magnets 47 facing the small stator cores 14 are changed in the circumferential direction, and thus the pulsation of the rotary torque applied to the permanent magnets 47 can be reduced. Accordingly, as similar to the third embodiment, it is possible to obtain a self-starting type axial gap synchronous motor in which the amplitude of the cogging torque generated between the permanent magnets 47 and the small stator cores 14 can be reduced, and vibration and noise can be suppressed.

### Fifth Embodiment

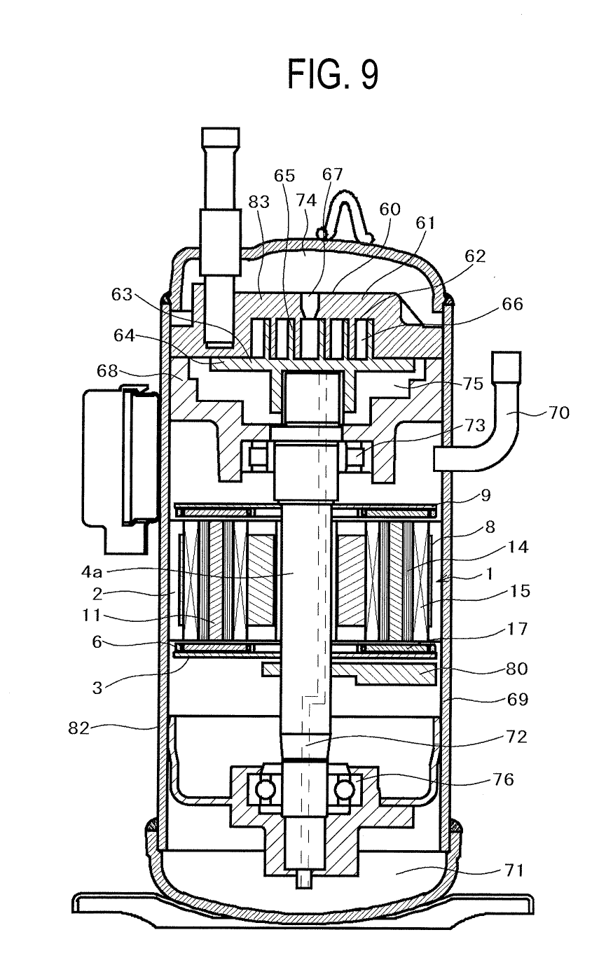

FIG. 9 shows a fifth embodiment of the present invention, and is a vertical cross-sectional view for showing a scroll compressor for a refrigeration cycle apparatus having the self-starting type axial gap synchronous motor described in any one of the first to fourth embodiments. In FIG. 9, constitutional elements having the same reference numerals as those in FIG. 1 correspond to the same or similar elements.

As shown in FIG. 9, a scroll compressor 82 includes a pressure vessel 69, a compression mechanical unit 83 that is provided on the upper side of the pressure vessel 69 and sucks and compresses refrigerant gas, a motor 1 that is provided near a middle portion of the pressure vessel 69 to drive the compression mechanical unit 83, and an oil reservoir 71 that is provided on the lower side of the pressure vessel.

The compression mechanical unit 83 is configured by meshing a fixed scroll obtained by erecting a rolled scroll wrap 62 on an end plate 61 with a pivoting scroll obtained by erecting a rolled scroll wrap 65 on an end plate 64. The pivoting scroll 63 is pivoted by a crankshaft 4a, so that compression operations are performed.

Among plural compression chambers 66 formed by the fixed scroll 60 and the pivoting scroll 63, the compression chamber that is positioned at the outermost part in the radial direction is moved toward the centers of the both scrolls 60 and 63 along with the pivoting movement of the pivoting scroll 63 and the volume thereof is gradually decreased. In addition, the compressed refrigerant gas is discharged to a discharging chamber 74 from a discharging port 67 provided near a middle portion of the fixed scroll 60. The discharged compressed-gas flows into the pressure vessel 69 under a frame 68 through gas channels (not shown) provided on the outer circumferential side of the fixed scroll 60 and the frame 68, and oil contained in the compressed gas is separated. As a result, the oil is discharged to the outside of the compressor from a discharging pipe 70 provided at a side wall of the pressure vessel 69. It should be noted that the reference numeral 75 denotes a back pressure chamber whose pressure is maintained at an intermediate pressure between a discharging pressure and a sucking pressure; 76, a secondary bearing; and 80, a balance weight.

As the motor 1, the self-starting type axial gap synchronous motor that is described in each embodiment with reference to FIGS. 1 to 8 is used. The motor 1 is rotated at a constant speed to drive the pivoting scroll 63. The oil in the oil reservoir 71 is provided to lubricate a sliding portion between the pivoting scroll 63 and the crankshaft 4a, and a bearing 73 through an oil hole 72 formed in the crankshaft 4a under the influence of a differential pressure between the pressure (discharging pressure) of the oil reservoir 71 and the oil hole 72 formed in the crankshaft 4a and under the influence of centrifugal force.

According to the embodiment, since the self-starting type axial gap synchronous motor that is described in each embodiment with reference to FIGS. 1 to 8 is used as an electric motor for driving a compressor, it is possible to realize a high-efficiency compressor that can be operated at a constant speed without using an inverter. Further, since the self-starting type axial gap motor is used, a downsized and high-output compressor can be obtained. Furthermore, the rotors 3 with the same configuration are provided on the both end sides of the stator 2 and the permanent magnets with different poles are arranged in the self-starting type axial gap synchronous motor. Thus, not only the output can be increased, but also opposing magnetic force is generated in the axial direction. Accordingly, a low-vibration scroll compressor can be obtained.

It should be noted that if the self-starting type axial gap motor described in the third embodiment is employed, excessively-high starting torque generated due to power-on phases can be reduced. Thus, it is possible to obtain a highly-reliable scroll compressor in which stress destruction of the bearing 73 and the pivoting scroll 63 can be prevented.

It should be noted that the self-starting type axial gap motor in each of the first to fourth embodiments can be similarly applied to not only the scroll compressor, but also a rotary or reciprocating compressor.

### Sixth Embodiment

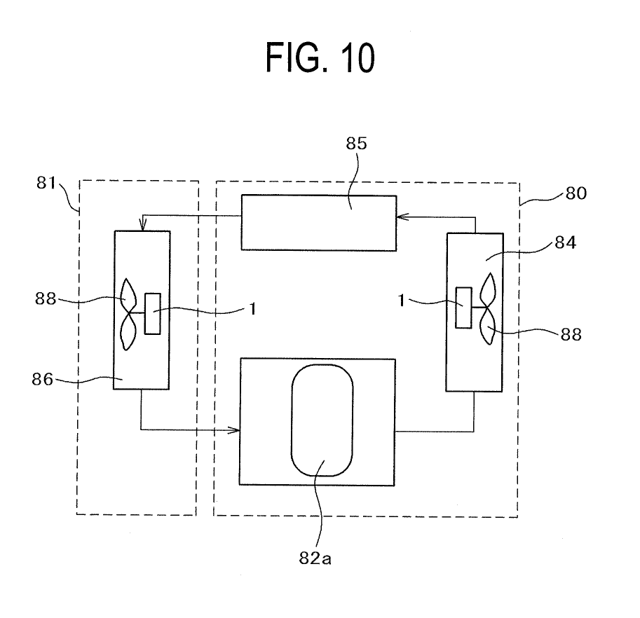

FIG. 10 is a refrigeration cycle configuration diagram for showing a refrigeration cycle apparatus having a self-starting type axial gap synchronous motor according to a sixth embodiment of the present invention.

FIG. 10 is a refrigeration cycle configuration diagram of an air conditioner as a refrigeration cycle apparatus. The reference numeral 80 denotes an outdoor unit, and 81 denotes an indoor unit coupled to the outdoor unit 80 through refrigeration pipes. The outdoor unit 80 includes a compressor 82a (for example, the scroll compressor 82 shown in FIG. 9), a condenser 84, an expansion valve 85, and the like. The compressor 82a contains refrigerant, and is coupled to the condenser 84 and the expansion valve 85 through the refrigerant pipes. Further, an evaporator 86 coupled to the refrigerant pipes is provided in the indoor unit 81.

A fan 88 and a motor for driving the fan 88 are provided in each of the condenser 84 and the evaporator 86, and as the motors, the self-starting type axial gap synchronous motors 1 described in each of the first to fourth embodiments are used. When the motors 1 are rotated, the fans 88 are also rotated, so that heat exchange between refrigerant flowing in heat exchangers of the condenser 84 and the evaporator 86 and ambient air is carried out.

In the refrigeration cycle shown in FIG. 10, the refrigerant is circulated in the arrow directions, and is compressed by the compressor 82. In addition, the refrigerant is sequentially allowed to flow into the condenser 84, the expansion valve 85, and the evaporator 86, so that a cooling operation is performed by the indoor unit 81. It should be noted that a four-way valve is provided on the discharging side of the compressor 82 to change the flowing direction of the refrigerant from the compressor, so that not only a cooling operation, but also a heating operation can be performed.

In the embodiment, the self-starting type axial gap synchronous motors 1 described in each of the first to fourth embodiments are used for the fans 88 of the evaporator and the condenser configuring the refrigeration cycle. Thus, the efficiency of the fans can be improved without using an inverter, and emissions of CO2 leading to global warming can be advantageously reduced by decreasing inputs. Further, the use of the self-starting type axial gap synchronous motors 1 described in the third or fourth embodiment leads to improvement in reliability of the fans.

It should be noted that the fans 88 are preferably propeller fans or turbo fans. Further, there has been described a case in the embodiment that the refrigeration cycle apparatus is used for an air conditioner. However, the refrigeration cycle apparatus can be similarly used for a refrigerator and a freezer.

As described above, according to each embodiment of the present invention, it is possible to obtain a self-starting type axial gap synchronous motor that can be started by a commercial electric power without using an inverter, and a compressor and an air conditioner using the same.

Further, in the self-starting type axial gap synchronous motor, the rotors provided on the both sides of the stator contribute to synchronous operations to generate the rotary torque even in synchronous operations by a commercial electric power. Accordingly, high rotary torque can be obtained as a whole. Thus, it is possible to obtain a self-starting type axial gap synchronous motor that can withstand a large load.

In the structure of the stator core of the motor in which the amorphous ribbon is wound around the nonmagnetic member, the eddy current generated at the stator core can be considerably reduced under the influence of the rotating magnetic fields at the time of rotation of the motor, and thus the efficiency of the motor can be improved while reducing a loss. Further, according to each embodiment, punching work for an amorphous core material is not necessary, and thus a die for the punching work is not needed, resulting in cost reduction and reduction in the number of manufacturing steps.

Further, in the self-starting type axial gap synchronous motor of the embodiment, the rotors are provided on the both end sides of the stator, and the permanent magnets with different poles are arranged. Thus, not only the output can be increased, but also opposing magnetic force is generated in the axial direction. Accordingly, a low-vibration motor can be obtained. Further, it is possible to minimize the cogging torque by employing the configuration described in the third or fourth embodiment.

What is claimed is:

1. A self-starting type axial gap synchronous motor comprising:
a stator in which plural small stators are arranged on the same circumference;
disc-shaped rotors in each of which plural permanent magnets facing the stator are arranged on the same circumference; and
a shaft coupled to the rotors, wherein
each of the disc-shaped rotors includes a metal frame that is provided so as to surround the plural permanent magnets arranged on the same circumference, and each of the metal frames is configured using a nonmagnetic and conductive material.

2. The self-starting type axial gap synchronous motor according to claim 1, wherein
each of the metal frames includes outer circumferential members that couple the outer circumferential sides of the permanent magnets in the circumferential direction, inner circumferential members that couple the inner circumferential sides of the permanent magnets in the circumferential direction, and radial members each of which is provided between the permanent magnets arranged in the circumferential direction and which couple the outer circumferential members to the inner circumferential members, and the permanent magnets are arranged in respective holes formed by the outer circumferential members, the inner circumferential members, and the radial members.

3. The self-starting type axial gap synchronous motor according to claim 2, wherein
each of the rotors includes a disk fixed to the shaft, and the metal frame and the permanent magnets are fixed to each of the disks.

4. The self-starting type axial gap synchronous motor according to claim 3, wherein
the rotors are oppositely arranged on both end sides of the stator so as to sandwich the stator.

5. The self-starting type axial gap synchronous motor according to claim 4, wherein
the material of each metal frame is aluminum or copper.

6. The self-starting type axial gap synchronous motor according to claim 5, wherein
the material of each permanent magnet is a rare-earth permanent magnet or a ferrite permanent magnet.

7. The self-starting type axial gap synchronous motor according to claim 6, wherein
the thicknesses of the permanent magnets are changed to change gaps between the permanent magnets and the stator in the circumferential direction, and the pulsation of rotary torque applied to the permanent magnets is reduced.

8. The self-starting type axial gap synchronous motor according to claim 1, wherein
each of the small stators configuring the stator is configured using a small stator core and a coil wound around the small stator core, and each of the small stator cores is configured by winding an amorphous ribbon around the outer circumference of a nonmagnetic member.

9. The self-starting type axial gap synchronous motor according to claim 8, wherein
the amorphous ribbon has an insulating film having a thickness of a few micrometers on one surface.

10. The self-starting type axial gap synchronous motor according to claim 9, wherein
a slit is provided on a lamination plane of each small stator core in the axial direction so as to cut the amorphous ribbon.

11. The self-starting type axial gap synchronous motor according to claim 9, wherein
plural slits are provided on at least anyone of the outer circumferential sides and the inner circumferential sides of both end surfaces of each small stator core in the radial direction.

12. The self-starting type axial gap synchronous motor according to claim 9, wherein
curved surfaces are provided at both ends of each small stator core to make a middle portion of each small stator core thicker in the axial direction and to make both sides thereof in the circumferential direction thinner in the axial direction, and the thickness of each small stator core is made non-uniform in the axial direction to reduce cogging torque.

13. A compressor comprising a compression mechanical unit and a motor that drives the compression mechanical unit, wherein
the motor is configured using the self-starting type axial gap synchronous motor according to claim 5.

14. A refrigeration cycle apparatus comprising a condenser and an evaporator, each having a fan driven by a motor, wherein
the motor of the fan provided in at least any one of the condenser and the evaporator is configured using the self-starting type axial gap synchronous motor according to claim 5.
